(19) United States
(12) Patent Application Publication
(10) Pub. No.: US 2004/0133772 A1
(43) Pub. Date: Jul. 8, 2004

(54) Firewall apparatus and method for voice over internet protocol

(75) Inventor: Kenneth J. Render, West Richland, WA (US)

Correspondence Address: Michael A. Kerr, Virtual Legal, Ste. 211, 777 E. William St., Carson City, NV, 89701, US

(73) Assignee: Battelle Memorial Institute, Richland, WA

(21) Appl. No.: 10/338,180

(22) Filed: Jan. 7, 2003

(51) Int. Cl. H04L 9/00; H04L 9/32

(52) U.S. Cl. 713/150

(57) ABSTRACT

The invention relates to an device and method for securing a Voice over Internet Protocol (VoIP) terminal with a telephone security (TSD) device having a terminal I/O component that interfaces with a VoIP terminal, a firewall component that watches a communication session, and a network I/O component that interfaces with a network. The method provides for the TSD to watch the communication session with the VoIP terminal. The TSD determines if the communication session has ended or has been initiated. The method enables the TSD to close a plurality of ports when the communication session with the VoIP terminal has ended. The TSD permits communications with the VoIP terminal when the communication session has been initiated.

### BACKGROUND

1. Field

The invention is related to Voice over Internet Protocol (VoIP) telephony systems and methods. More particularly, the systems and methods are related to providing a firewall for VoIP applications.

2. Description of Related Art

Previously, enterprise-wide telephone networks had the same basic components, including end user equipment such as telephones with premises wiring and back end gear that included Private Branch Exchanges (PBXs) and trunk lines. However, the convergence of voice and data services on a single, next generation packet based network is on the horizon and will eventually replace circuit-switched networks. Unfortunately, by moving voice signals as packets of data over the Internet and by shifting the connection of computerized telephone switches to the Internet, telephone equipment will now become susceptible to the vulnerabilities inherent to computer systems.

Voice over Internet Protocol (VoIP) is the technology that enables real-time transmission of voice signals as packets of data over the Internet by routing voice data via the public Internet network. VoIP is comprised of several interconnected processes that convert voice signals into a stream of packets on a packet network. VoIP allows the human voice to travel simultaneously over a single packet network line with other data transmissions.

Prior enterprise-wide corporate telephone networks had the same basic components including end-user equipment, e.g. telephones, premises wiring, and back-end gear (PBXs, trunk lines). During the transition to VoIP, Internet Protocol (IP) equipment will be replacing analog handsets and wiring. Additionally, IP-based equivalents will be filling in for PBX and/or interconnect wiring. Although voice and data will share portions of the same network, typical VoIP network systems are different from data network systems due to the quality of service (QoS) requirements for voice communications.

Historic telephony protection strategies include the Telephone Security Group (TSG) Standards which were written back in the early 1980's to prescribe the measures necessary to protect audio discussion from eavesdropping and component manipulation. These standards specifically addressed the existing analog telephone instruments and associated premise wiring and the Public Switched Telephone Network (PSTN). The TSG standards also established requirements for planning, installing, maintaining, and managing a computerized telephone system (CTS). A CTS is any telephone system that uses centralized stored program computer technology to provide switched telephone networking features and services. However, these protection measures assume dedicated premise wiring. VoIP breaks that assumption in a fundamental way because the transmission channel becomes part of the data network.

The TSG standards were later re-organized and re-chartered as the National Telecommunications Security Working Group (NTSWG). The NTSWG is responsible for security countermeasures for all telecommunications systems and components used within a classified information area. Current NTSWG philosophies include clarifying requirements and actively seeking industry participation to stimulate industry interest in providing inherently safe telecommunications that can be directly applied to national protection requirements. However, the cost of implementing the NTSWG strategies appears to be too costly.

### SUMMARY

The invention is an apparatus and method for securing a Voice over Internet Protocol (VoIP) terminal with a telephone security device (TSD) having a terminal I/O component, a firewall component, and a network I/O component. The terminal I/O component is configured to interface with the VoIP terminal. The network I/O component is configured to interface with the network during a communication session with the VoIP terminal. The firewall component is operatively coupled with the terminal I/O component and the network I/O component. The firewall component is configured to watch or monitor a communication session with the VoIP terminal to determine if the communication session has ended or has been initiated.

The firewall component is configured to close a plurality of ports when the communication session with the VoIP terminal has been terminated. The firewall is configured to permit audio, video and data communications when the communication session has been initiated. In the illustrative embodiment, the firewall comprises a central processing unit (CPU) and read only memory (ROM). The telephone security device also comprises an indicator light in communication with the firewall. An indicator light is configured to identify when the communication session with said VoIP terminal has been initiated or has ended.

The TSD provides a method for securing communications with the VoIP terminal by watching or monitoring the communication session with the VoIP terminal to determine if the communication session has ended or has been initiated. The method enables the TSD to close a plurality of ports when the communication session has ended. The plurality of ports that are closed include ports that communicate audio signals, video signals, and data signals. The method also provides for the communicating of control signals that are configured to manage the communication session. The control signals include communication control signals and call control signals.

In operation, the method for securing the VoIP terminal includes determining whether a communications session has been initiated or has ended. The method enables the TSD to close a plurality of ports when the communication session with the VoIP terminal has ended. When the communication session with the VoIP terminal is initiated, the TSD allows the communication session to occur. The method displays the status of the TSD by activating the indicator light that is configured to communicate when a communication session has ended or has been initiated. In an illustrative embodiment, all available ports for communicating audio signals are closed when there are no audio communications with the VoIP terminal.

### BRIEF DESCRIPTION OF THE DRAWINGS

Preferred embodiments are shown in the accompanying drawings wherein:

FIG. 1 shows an illustrative telephony system configured to communicate packets of voice data.

FIG. 2 shows an illustrative Internet Protocol (IP) telephony system employing a plurality of Telephone Security Devices (TSDs).

FIG. 3 shows a portion of an illustrative Voice over Internet Protocol (VoIP) telephony system.

FIG. 4 shows an illustrative TSD.

FIG. 5 shows a block diagram of the illustrative TSD.

FIG. 6 shows a flowchart for performing a method for securing an IP terminal with the TSD.

### DETAILED DESCRIPTION

In the following detailed description, reference is made to the accompanying drawings, which form a part of this application. The drawings show, by way of illustration, specific embodiments in which the invention may be practiced. It is to be understood that other embodiments may be utilized and structural changes may be made without departing from the scope of the claims of this patent.

The International Telecommunications Union (ITU) was created in March 1993 to ensure an efficient and on-time production of high quality standards covering all fields of telecommunications. The ITU has developed the H.323 standard which is the dominant standard for VoIP. The H.323 standard also allows VoIP to be adapted for transmission over a broadband communication system. Another VoIP standard that is being developed is the Session Initialization Protocol (SIP). Other standards under development include the Simple Gateway Control Protocol and the Internet Protocol Device Control.

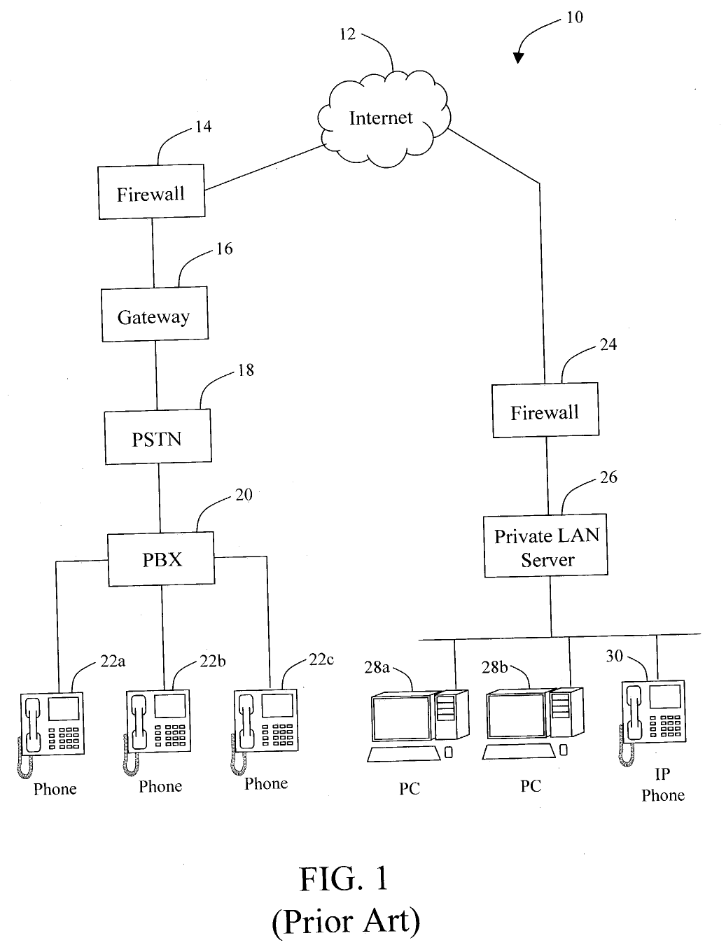

Referring to FIG. 1 there is shown an illustrative telephony system 10 configured to perform VoIP communications between a PBX phone and an IP terminal. Communications for the VoIP traffic are conducted using the Internet 12. A voice firewall 14 is operatively coupled to the Internet 12. The voice firewall 14 is configured to secure voice communications from the Internet 12 to the illustrative PBX phone. The voice firewall 14 is operatively coupled to an IP gateway 16 that serves as a bridge between an IP network and the Public Switched Telephone Network (PSTN) 18. The VoIP gateway 16 permits communications from a PBX phone with an IP terminal. The IP gateway 16 could also be operatively coupled to an analog phone or another analog device. In the illustrative telephone system 10, the PSTN 18 is in communication with the private branch exchange (PBX) 20 that is coupled to a set of PBX phones 22a, 22b, and 22c.

An illustrative VoIP network system also interfaces with the Internet 12. The VoIP network includes a firewall 24 that protects a private local area network (LAN) by blocking incoming traffic. The firewall 24 is operatively coupled to a LAN server 26 which is communicatively coupled to a plurality of IP terminals. By way of example and not of limitation, the IP terminals include personal computers 28a, 28b, and IP phone 30. Additionally, the IP terminal may also include any other device configured to perform VoIP communications such as wireless phones or wireless personal digital assistants.

In the illustrative telephone system 10, the firewall 24 operates by leaving many ports open. It shall be appreciated by those of ordinary skill in the art of VoIP communications, a port is an endpoint to a logical connection in the way a client program specifies a specific server program on a computer in a network. Port numbers range from 0 to 65536. For the illustrative H.323 standard, at least two Transmission Control Protocol (TCP) or User Datagram Protocol (UDP) ports have to be opened during a telephone call. Two additional ports may also be opened for Real-Time Control Protocol (RTCP) to monitor performance.

In operation, the VoIP ports are opened in sequences starting with Port 1024. Typically, two to four UDP ports must be open during the duration of each call. By way of example and not of limitation, the Port 1024 is opened as an illustrative talk port and Port 1025 monitors Port 1024. Another Port 1026 is used to listen, and Port 1027 monitors Port 1026. If more than one call is supported, more ports need to be opened.

There are a variety of complex functions performed by the centralized firewall 24 for VoIP communications. These firewall functions include determining whether an incoming voice packet is legitimate, opening and closing the appropriate ports, avoiding “jitter” caused by opening and closing ports, receiving updates about whether a port is closed or opened, keeping track of private IP addresses so returning traffic can be routed to the sending device, and supporting simultaneous phone calls. Although it may be possible for the firewall 24 to handle the complex firewall functions, the centralized firewall 24 is not designed to control activities which occur behind the firewall. Thus, the centralized firewall 24 cannot address the situation in which an individual operating behind the centralized firewall performs an unauthorized function such as hacking into another IP terminal.

The Telephone Security Device (TSD) can be used in conjunction with the central firewall 24 to assist in performing the firewall functions and to protect an IP terminal from activities behind the central firewall 24. An illustrative embodiment of the IP terminal is an H.323 terminal. Notice that for purposes of this patent, the IP terminal is also referred to as a VoIP terminal and these terms are used interchangeably.

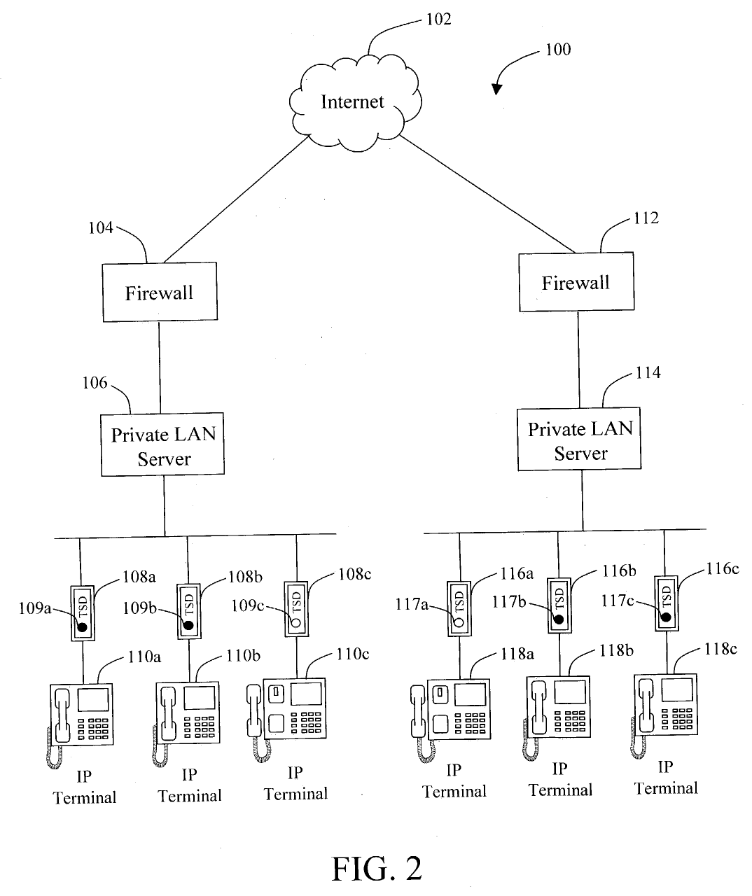

Referring to FIG. 2 there is shown an illustrative Internet Protocol (IP) telephony system 100 employing a plurality of Telephone Security Devices (TSDs). The TSD is a firewall for securing VoIP communications with an IP terminal. In this illustrative embodiment, the telephone security system applies the ITU H.323 standard. For purposes of this illustrative embodiment, the TSD is H.323 compliant and can be applied to any compliant VoIP telephony system. It shall be appreciated by those skilled in the art having the benefit of this disclosure that the TSD compliance is not limited to the H.323 standard, and the TSD may be adapted to work for a variety of different VoIP standards, such as the standards identified above.

The illustrative telephony system 100 permits communications between two IP terminals. The Internet 102 is operatively coupled to a private network that includes an IP firewall 104 which communicates with a private LAN server 106. The LAN 106 communicates with a plurality of devices including TSDs 108a, 108b and 108c that control the ports for IP terminals 110a, 10b, and 110c, respectively. Each TSD 108a, 108b and 108c has an indicator light 109a, 109b and 109c that identifies the status of the TSD firewall. The Internet 102 is also coupled to another private network having a IP firewall 112 which communicates with private LAN server 114. The LAN server 114 communicates with TSDs 116a, 116b and 116c which control the ports for IP terminals 118a, 118b, and 118c, respectively. The indicator lights 117a, 117b and 117c identify the status for each TSD.

Upon closer inspection, IP terminals 110c and 118a are in the “off-hook” position. The off-hook position is a telephony term which refers to the telephone being in use when the receiver is physically off the hook. The remaining IP terminals are in the “on-hook” position. The on-hook position refers to the phone not being in use. For illustrative purposes the IP terminal 110c is in communication with IP terminal 118a, and as a result the respective TSD firewalls are not permitting audio signals to communicated using the appropriate ports.

Each of the IP terminals or VoIP terminals communicate through the transmission of information streams. For purposes of this patent, these information streams are classified as audio signals, video signals, data signals, communication control signals, and call control signals. Audio signals contain digitized and coded speech that are typically accompanied with an audio control signal. Video signals contain digitized and coded motion video and are transmitted at a rate no greater than that selected as a result of the capability exchange. Typically, the video signal is accompanied by a video control signal. Data signals include still pictures, facsimile, documents, computer files and other data streams. Communication control signals pass control data between remote like functional elements and are used for capability exchange, opening and closing logical channels, mode control and other functions that are part of communications control. Call control signals are used for call establishment, disconnect and other call control functions. For the H.323 standard, these information streams are formatted and sent to the network interface as described by Recommendation H.225.0.

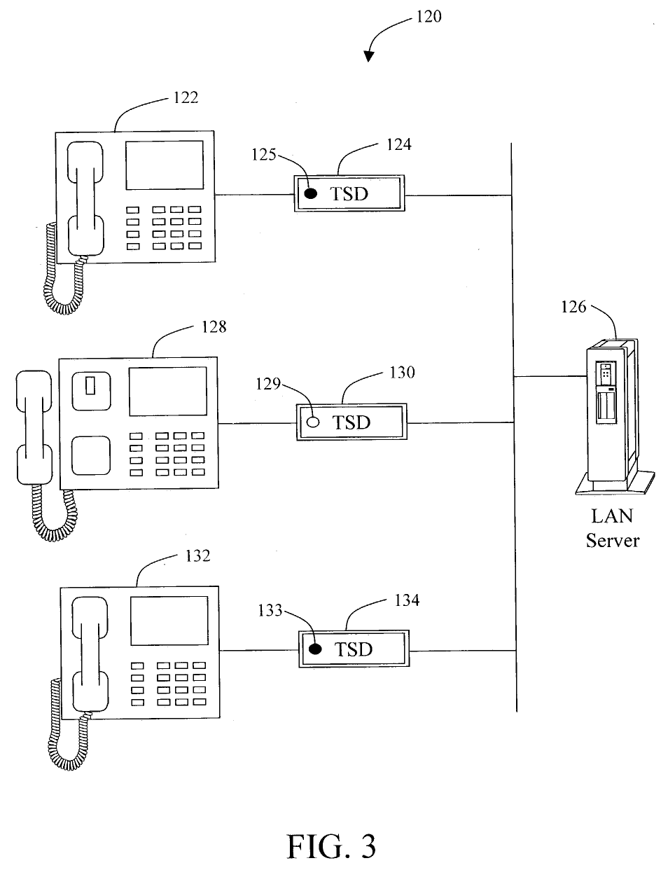

Referring to FIG. 3 there is shown a portion of an illustrative VoIP telephony system 120 using a TSD to secure each VoIP terminal. The illustrative VoIP system 120 includes a VoIP terminal 122 operatively coupled to a telephone security device (TSD) 124. The VoIP terminal 122 is represented by a phone that is in the on hook position, i.e. phone not in use. The TSD 124 is fully enabled and is closing non-communicating ports that are available to communicate audio signals, video signals, and data signals. The TSD indicator light 125 is “on” indicating that the TSD firewall is operational and is closing non-communicating ports. While closing the non-communicating ports, the TSD 124 is also watching for control signals that indicate when a communications session is initiated. When a communication session has been initiated, audio signals, video signals, or data signals can be communicated through the appropriate ports.

Another VoIP terminal 128 is operatively coupled to a TSD 130. The VoIP terminal 128 is in an off-hook position, i.e. in use, and the TSD indicator light 129 is “off”. When the VoIP terminal 128 is in use, a communication session is taking place. During the communication session, audio signals, video signals, or data signals are communicated through the TSD 130 to the VoIP terminal 128. While the VoIP terminal 128 is in the off hook position, the TSD watches the communication session to determine if the communication session has ended. Once the communication session has ended, the TSD 130 closes non-communicating ports that are available for communicating audio signals, video signals, and data signals.

The remaining IP terminal 132 is not in use. TSD indicator light 133 associated with TSD 134 is “on” and the TSD firewall is fully enabled. Thus, non-communicating ports are closed. Both TSD 130 and TSD 134 are communicatively coupled to the illustrative LAN server 126.

In the illustrative telephony system 120, the H.323 standard is used to move the audio, video or data traffic using the Real-Time Transport Protocol (RTP). RTP is an Internet protocol for transmitting real-time data such as audio. There is also a control component referred to as Real-Time Transport Control Protocol (RTCP) that provides quality-of-service feedback. RTP itself does not guarantee real-time delivery of data, but it does provide mechanisms for the sending and receiving of applications to support streaming data. Typically, RTP runs on top of the UDP protocol.

In operation, the illustrative TSD 124 secures traffic to the respective VoIP terminal by reading the H.323 traffic and deciding which ports are being negotiated for RTP/RTCP. The TSD 124 then opens ports between the relevant communicating IP addresses. The TSD 124 may also have to monitor the H.323 sessions and tear down the UDP ports it opened when the call closes.

Thus, the illustrative TSD 124 secures VoIP terminal 122′ by determining whether a communication session has been initiated or terminated. The TSD is fully enabled and closing non-communicating ports, when the VoIP terminal 122 is in an off-hook position and there is no active communication session. When the VoIP terminal is in use, like VoIP terminal 128, the TSD 130 permits audio signals, video signals or data signals to be communicated to the VoIP terminal 128. In general, each TSD allows a plurality of control signals that manage the communication session to be transmitted between the VoIP terminal and the LAN network 126. Typically, the control signals include communications control signals and call control signals.

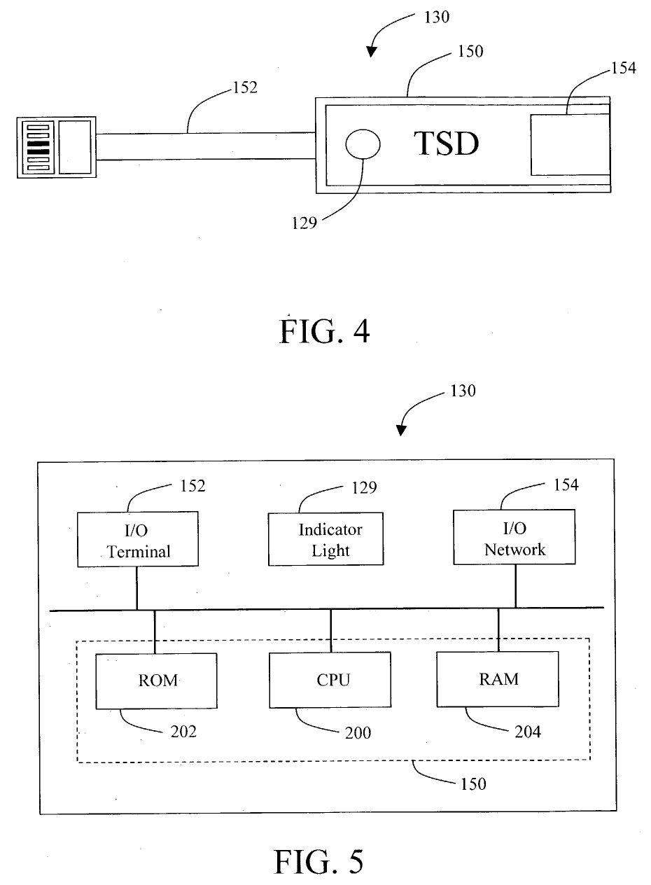

Referring to FIG. 4 there is shown a more detailed view of illustrative TSD 130. The illustrative TSD 130 includes a terminal I/O component that includes an illustrative RJ-45 connection 152. The TSD 150 also includes a network I/O component 154 adapted to receive an illustrative RJ-45 connection that is operatively coupled to a network with LAN server 126. Although each of the interfaces described in the illustrative embodiment refers to a wired network, the TSD 130 can also be adapted to a wireless network. The illustrative TSD 130 houses a firewall 150 that is to operatively coupled to the terminal I/O component 152 and the network I/O component 154. The terminal I/O component 152 includes CAT-5 cabling 158. The indicator light 129 provides a visible indicator of the status of the firewall as described above.

The firewall 150 is configured to watch the communication session with the VoIP terminal 128 to determine if the communication session has ended or has been initiated. In operation, the firewall 150 is configured to close at least one communication port when the communication session with the VoIP terminal has been terminated. Typically, a plurality of ports are closed. The firewall 150 is configured to transmit audio signals, video signals or data signals to be communicated when the communication session has been initiated. In the illustrative embodiment, the firewall 150 comprises a central processing unit (CPU) and read only memory (ROM). The telephone security device 130 also comprises an indicator light operatively coupled to the firewall 150 and configured to identify whether the VoIP terminal 128 is secure.

Referring to FIG. 5 there is shown an illustrative block diagram of the illustrative TSD 130. The illustrative TSD 130 comprises a terminal I/O component 152, a network I/O component 154, and a firewall 150 that includes a central processing unit (CPU) 200, a read only memory (ROM) 202 circuit, and a random access memory (RAM) 204 circuit. The terminal I/O component 152 is configured to interface with the VoIP terminal 128 with an illustrative RJ-45 connector. The network I/O component 254 is configured to interface with a network having an illustrative RJ-45 connector. A bus permits the transfer of data, address, and control signals between each of the components.

In operation, each TSD operates as a dynamic hardware firewall specifically designed to comply with the ITU H.323 standard or subsequently adopted international standards. Each TSD 130 provides a positive disconnect between non-communicating port circuits and closes any potential audio, video or data path when the associated telephone instrument or IP terminal is in the on-hook position, i.e. is not in use. The positive disconnect permits each TSD to perform the firewall function of preventing unauthorized access. When the VoIP terminal is not in use, the TSD is enabled and the TSD firewall is operational.

When an illustrative H.323 session is initiated, i.e. the VoIP terminal is in use, two specific TCP port numbers are requested. For illustrative purposes, the two specific ports include the combination of ports 1503 and 1720, or the combination of ports 1414 and 1424. For purposes of this illustrative example, the ports 1503 and 1720 are used for call setup and call control. A H.323 application that wishes to connect to another H.323 user will connect to that other VoIP terminal on both ports 1503 and 1720. Using these two connections, the H.323 application negotiates the UDP ports to use for transferring audio signals, video signals or data signals.

As previously noted, the H.323 standard specifies the use of the RTP protocol for data transfer. The RTP protocol uses up to two UDP ports. The actual port numbers that are negotiated by H.323 are indeterminable, but conform to the RTP standard. Typically, the two ports used for communicating information streams include a data port for data transfer and a control port for control information. The data port typically has large numbers of small, fixed sized packets. The control port communicates lower data volumes that can be relatively irregular in packet size and frequency. By way of example and not of limitation, the ports that are available include some of the registered ports that range from ports 1,024 through 49,151 and some of the dynamic and/or private ports that range from 49,152 through 65,535.

When the VoIP terminal is in use, the TSD 150 watches the ports and determines if the communication session has been terminated. During the communication session, the indicator light is “on” indicating that firewall to the IP terminal is not performing the security function of closing non-communicating ports. The intent behind having the indicator light “on” is to communicate that the phone is no longer secure.

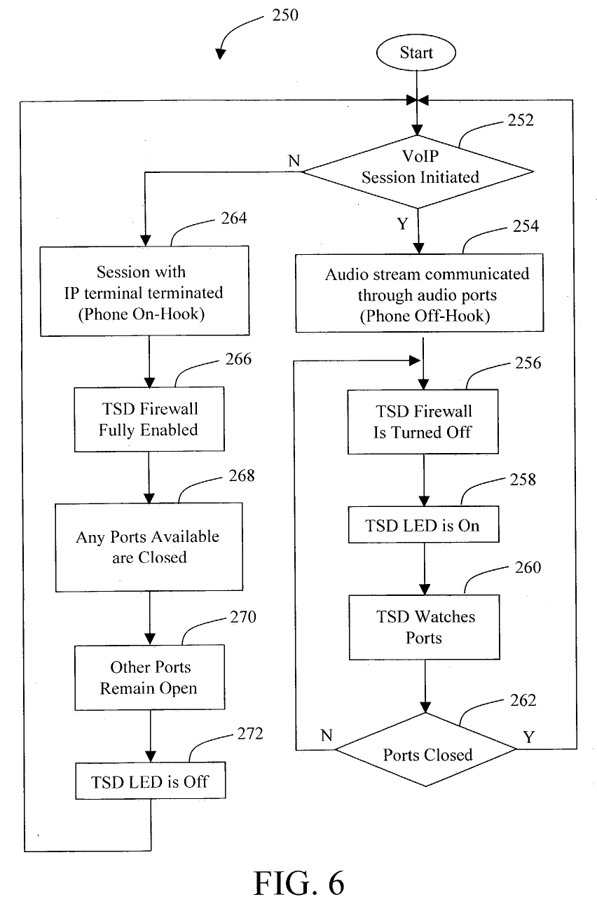

Referring to FIG. 6 there is shown a flowchart for performing a method 250 for securing an IP terminal with a TSD. The method 250 is applied to information streams including audio signals, video signals, data signals or any combination thereof. The method is initiated at a decision diamond 252 in which the TSD determines whether a VoIP communication session has been initiated or has ended.

If a VoIP session has been initiated, the method proceeds to process block 254 in which an information stream is communicated through at least one port. For the illustrative IP terminal 128, the information stream is communicated through at least one port to the IP terminal. When the illustrative IP terminal 128 is in use, the TSD 130 firewall is effectively disabled or turned off. Thus the TSD firewall does not close ports available for communicating audio signals, video signals or data signals. To reflect that the TSD 130 firewall has been turned off, the method proceeds to process block 258 in which the indicator light 162 is turned on. By turning the light on, this means that the VoIP terminal is not secure. The method then proceeds to process block 260.

In process block 260, the TSD 130 watches the communicating ports to determine whether a communication session has ended. The method then proceeds to decision diamond 262 where it is determined whether the communicating ports needed for transferring audio signals, video signals or data signals are being used. If the determination is made that the communicating ports are still being used, the method returns to process block 256 to make sure the TSD firewall continues to be turned off. However, if it is determined that the communicating ports have closed because the communication session has ended, then the method returns to decision diamond 252 to determine the status for the IP terminal.

If the determination at decision diamond 252 is that the VoIP session has been terminated, then the method proceeds to process block 264. In process block 264, the on-hook status of the VoIP terminal is confirmed. The method then proceeds to process block 266 where the firewall within the illustrative TSD 130 is enabled and a plurality of non-communicating ports are closed. The method permits non-communicating ports that would otherwise be open and be subject to attack to be closed as described by process block 268.

The method permits some ports to remain open as described by process block 270. By way of example and not of limitations, the ports 1503 and 1720 that are used for call setup and call control communications with the VoIP terminal remain open. In general, ports configured to transmit communication control signals and call control signals remain open. Port configured to communicate audio signals, video signals, and data signals are closed.

The method then proceeds to process block 272 where the indicator light 160 is turned off, reflecting that there is little or no danger to the IP terminal because the firewall has been enabled. The method then returns once again to decision diamond 252 to determine the state of the IP terminal.

In alternative embodiment, the TSD device and methods described above may also be used in conjunction with the Inquiry Management and Analytical Capability (IMAC) systems and methods operated by the Office of Counterintelligence. Additionally, the TSD described above can be adapted to operate with other standards configured to communicate audio signals, video signals, or data signals with a packet switched network.

Although the description above contains many illustrative embodiments, these should not be construed as limiting the scope of the invention but as merely providing illustrations of some of the presently preferred embodiments of this invention. Thus, the scope of the invention should be determined by the appended claims and their legal equivalents rather than by the illustrative examples given.

What is claimed is:

1. A method for securing a Voice over Internet Protocol (VoIP) terminal with a telephone security device (TSD) operatively coupled between said IP terminal and a VoIP network, comprising:
permitting a communication session with said VoIP terminal to be conducted; and
enabling said TSD to close a plurality of ports when said communication session has ended.

2. The method of claim 1 wherein said plurality of ports that are closed are ports that communicate audio signals.

3. The method of claim 1 wherein said plurality of ports that are closed are ports that communicate video signals.

4. The method of claim 1 wherein said plurality of ports that are closed are ports that communicate data signals.

5. The method of claim 1 further comprising communicating a plurality of control signals through said TSD, said plurality of control signals configured to manage said communication session.

6. The method of claim 5 wherein said plurality of control signals comprise a plurality of communications control signals and a plurality of call control signals.

7. A method for securing a Voice over Internet Protocol (VoIP) terminal with a telephone security device (TSD) having a terminal I/O component that interfaces with said VoIP terminal, and a network I/O component configured to interface with a VoIP network, comprising:
watching a communication session with said VoIP terminal to determine if said communication session has ended or has been initiated;
enabling said TSD to close a plurality of ports when said communication session with said VoIP terminal has ended; and
permitting communications with said VoIP terminal when said communication session has been initiated.

8. The method of claim 7 further comprising communicating a plurality of control signals configured to manage said communication session.

9. The method of claim 8 wherein said plurality of control signals comprise a plurality of communications control signals and a plurality of call control signals.

10. The method of claim 9 wherein said communication session comprises a stream of audio signals.

11. The method of claim 9 wherein said communication session comprises a stream of video signals.

12. The method of claim 9 wherein said communication session comprises a stream of data signals.

13. The method of claim 9 further comprising activating an indicator light associated with said TSD, said indicator light configured to identify whether said communication session has ended or has been terminated.

14. A telephone security device for managing secure communications with a Voice over Internet Protocol (VoIP) terminal, comprising:
a terminal I/O component configured to interface with a VoIP terminal;
a network I/O component configured to interface with a network during a communication session with said VoIP terminal; and
a firewall operatively coupled with said terminal I/O component and said network I/O component, said firewall configured to watch said communication session with said VoIP terminal to determine if said communication session has been terminated or initiated.

15. The telephone security device of claim 14 wherein said firewall is configured to close a plurality of ports when said communication session with said VoIP terminal has been terminated.

16. The telephone security device of claim 15 wherein said firewall is configured to communicate audio signals when said communication session has been initiated.

17. The telephone security device of claim 16 wherein said firewall is configured to communicate data signals when said communication session has been initiated.

18. The telephone security device of claim 17 wherein said firewall is configured to communicate video signals when said communication session has been initiated.

19. The telephone security device of claim 18 wherein said firewall comprises a central processing unit (CPU) and read only memory (ROM).

20. The telephone security device of claim 19 further comprising an indicator light in communication with said firewall, said indicator light configured to identify when said communication session with said VoIP terminal has been initiated or has ended.
